(19) United States
(12) Patent Application Publication
(10) Pub. No.: US 2024/0421345 A1
(43) Pub. Date: Dec. 19, 2024

(54) SOLID ELECTROLYTE WITH HIGH-ENTROPY GARNET-TYPE STRUCTURE AND ALL SOLID-STATE LITHIUM-ION BATTERY

(71) Applicant: National Tsing Hua University, Hsinchu City (TW)

(72) Inventors: Chun-Han Kuo, Hsinchu City (TW); Han-Yi Chen, Hsinchu City (TW)

(73) Assignee: National Tsing Hua University, Hsinchu City (TW)

(21) Appl. No.: 18/351,503

(22) Filed: Jul. 13, 2023

(30) Foreign Application Priority Data
Jun. 15, 2023 (TW) 112122372

(51) Int. Cl. H01M 10/0562; H01M 10/0525

(52) U.S. Cl. CPC H01M 10/0562; H01M 10/0525; H01M 2300/0071

(57) ABSTRACT

A solid electrolyte with high-entropy garnet-type structure includes a high-entropy garnet-type structure oxide represented by following formula (1):

LiₐLa₃Zr_{b}Ta_{c}M1_{d}M2ₑM3_{f}O₁₂ (1)

In the formula (1), M1, M2, and M3 are respectively W, Sc, Sn, Nb, Y, Si, Sb, Te, Ti, Mo, Mg, or Nd, b+c+d+e+f=2, 5<a<8, 0.01<b<0.6, 0.01<c<0.6, 0.01<d<0.6, 0.01<e<0.6, and 0≤f<0.6. A solid electrolyte of an all solid-state lithium-ion battery includes the solid electrolyte with high-entropy garnet-type structure.

### CROSS-REFERENCE TO RELATED APPLICATION

This application claims the priority benefit of Taiwan application serial no. 112122372, filed on Jun. 15, 2023. The entirety of the above-mentioned patent application is hereby incorporated by reference herein and made a part of this specification.

### BACKGROUND

### Technical Field

The disclosure relates to a solid electrolyte with high-entropy garnet-type structure and an all solid-state lithium-ion battery including the aforementioned solid electrolyte.

### Description of Related Art

In recent years, due to the wide application of mobile apparatus, electric vehicles, and renewable energy in human life, the demand for energy storage equipment has also increased, and the use of lithium-ion batteries has been greatly increased.

However, conventional lithium batteries, which use liquid organic electrolytes, pose safety concerns in the event of overcharging or short-circuiting. Especially in electric vehicles, in the event of an accident, there is a risk of battery short-circuiting and subsequent vehicle fires. Thus, the development of solid-state batteries is considered a solution that can replace conventional batteries and mitigate the dangers of combustion and explosion.

There have been studies on using garnet-type structure oxide as the material of lithium-ion electrolytes. However, garnet-type structure oxide is prone to react with water vapor and carbon dioxide in the atmosphere during fabrication and storage, leading to the formation of lithium carbonate possessing low ionic conductivity on their surfaces. This, in turn, reduces the total lithium-ion conductivity of the materials.

### SUMMARY

The disclosure provides a solid electrolyte with high-entropy garnet-type structure, which is adapted for all solid-state lithium-ion batteries that pursue high energy storage and have safety requirements.

The disclosure further provides an all solid-state lithium-ion battery including the aforementioned solid electrolyte with high-entropy garnet-type structure.

The solid electrolyte with high-entropy garnet-type structure of the disclosure is a high-entropy garnet-type structure oxide represented by the following formula (1).

LiₐLa₃Zr_{b}Ta_{c}M1_{d}M2ₑM3_{f}O₁₂ (1)

In the formula (1), M1, M2, and M3 are respectively W, Sc, Sn, Nb, Y, Si, Sb, Te, Ti, Mo, Mg, or Nd, b+c+d+e+f=2, 5<a<8, 0.01<b<0.6, 0.01<c<0.6, 0.01<d<0.6, 0.01<e<0.6, and 0≤f<0.6.

In an embodiment of the disclosure, b, c, d, e, and f in the formula (1) have identical values.

In an embodiment of the disclosure, M1, M2, and M3 in the formula (1) are W, Nb, and Y.

In an embodiment of the disclosure, the high-entropy garnet-type structure oxide includes Li_{5.8}La₃Zr_{0.4}Ta_{0.4}Nb_{0.4}Y_{0.4}W_{0.4}O₁₂ or Li_{6.4}La₃Zr_{0.4}Ta_{0.4}Nb_{0.4}Y_{0.6}W_{0.2}O₁₂.

In an embodiment of the disclosure, f in the formula (1) is 0.

In an embodiment of the disclosure, b, c, d, and e in the formula (1) have identical values.

In an embodiment of the disclosure, the high-entropy garnet-type structure oxide includes Li_{6.5}La₃Zr_{0.5}Ta_{0.5}Nb_{0.5}Y_{0.5}O₁₂.

In an embodiment of the disclosure, the high-entropy garnet-type structure oxide is prepared by solid state sintering.

The all solid-state lithium-ion battery of the disclosure includes a positive plate, a negative plate, and the aforementioned solid electrolyte with high-entropy garnet-type structure. The positive plate is disposed opposite to the negative plate, and the solid electrolyte is disposed between the positive plate and the negative plate.

Based on the above, compared with the known garnet-type structure oxide, the high-entropy garnet-type structure oxide of the disclosure exhibits structural stability and excellent atmospheric stability. Thus, using the same as a solid electrolyte material may improve the stability of ion conductivity, and has a capacity close to that of a liquid battery after assembling a full battery.

In order to make the above-mentioned features and advantages of the disclosure comprehensible, embodiments accompanied with drawings are described in detail below.

### BRIEF DESCRIPTION OF THE DRAWINGS

FIG. 1 is a structural schematic view of an all solid-state lithium-ion battery according to an embodiment of the disclosure.

FIG. 2 is an X-ray crystal diffraction (XRD) diagram of products of Preparation examples 1˜2.

FIG. 3 is a scanning electron microscopy (SEM)/energy-dispersive X-ray spectroscopy (EDX) analysis image of products of Preparation examples 1-5.

FIG. 4 is a diagram showing a volt-ampere curve of a battery prepared by Preparation example 1.

FIG. 5 is a diagram showing ionic conductivity curves of products of Preparation examples 1-5 changing with temperature.

FIG. 6 is an Arrhenius plot of products of Preparation examples 1-5.

FIG. 7 is a diagram showing ionic conductivity curves of products of Preparation examples 1-5 changing with number of days.

FIG. 8 is a test diagram of charge/discharge cycle of an all solid-state lithium-ion battery.

FIG. 9 is a test diagram of charge/discharge cycle of a liquid electrolyte battery.

### DESCRIPTION OF THE EMBODIMENTS

The following content provides various implementation examples for realizing different features of the disclosure. However, these examples are merely illustrative and should not be construed to limit the scope and applications of the disclosure.

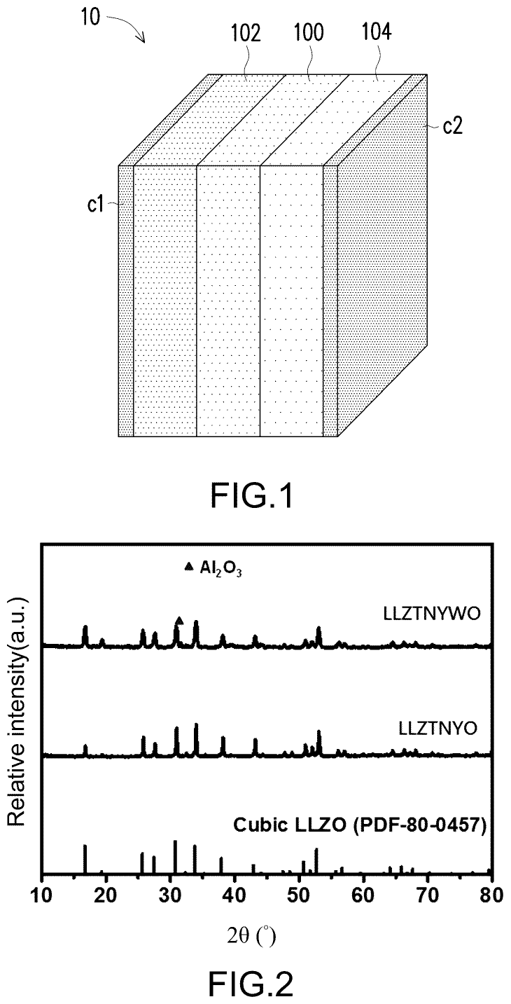

FIG. 1 is a structural schematic view of an all solid-state lithium-ion battery according to an embodiment of the disclosure. In FIG. 1, an all solid-state lithium-ion battery 10 includes a positive plate 102, a negative plate 104, and a solid electrolyte 100 with high-entropy garnet-type structure. The positive plate 102 is disposed opposite to the negative plate 104, and the solid electrolyte 100 is disposed between the positive plate 102 and the negative plate 104. In addition.

outer sides of the positive plate 102 and the negative plate 104 may also be configured with a current collector c1 and a current collector c2.

In this embodiment, the solid electrolyte 100 with high-entropy garnet-type structure is a high-entropy garnet-type structure oxide represented by the following formula (1).

LiₐLa₃Zr_{b}Ta_{c}M1_{d}M2ₑM3_{f}O₁₂ (1)

In the formula (1), M1, M2, and M3 are respectively W, Sc, Sn, Nb, Y, Si, Sb, Te, Ti, Mo, Mg, or Nd, b+c+d+e+f=2, 5<a<8, 0.01<b<0.6, 0.01<c<0.6, 0.01<d<0.6, 0.01<e<0.6, and 0≤f<0.6.

In one embodiment, b, c, d, e, and f in the formula (1) have identical values, for example. b, c, d, e, and f are all 0.4.

In one embodiment, M1, M2, and M3 in the formula (1) are W, Nb, and Y. For example, the high-entropy garnet-type structure oxide may be Li_{5.8}La₃Zr_{0.4}Ta_{0.4}Nb_{0.4}Y_{0.4}W_{0.4}O₁₂ or Li_{6.4}La₃Zr_{0.4}Ta_{0.4}Nb_{0.4}Y_{0.6}W_{0.2}O₁₂.

In another embodiment, f in the formula (1) is 0, then the aforementioned high-entropy garnet-type structure oxide becomes a quaternary high-entropy structure, such as LiₐLa₃Zr_{b}Ta_{c}M1_{d}M2ₑO₁₂. In such an embodiment, b, c, d, and e may have identical values, for example, b, c, d, and e are all 0.5. For example, the high-entropy garnet-type structure oxide may be Li_{6.5}La₃Zr_{0.5}Ta_{0.5}Nb_{0.5}Y_{0.5}O₁₂.

In an embodiment of the disclosure, the high-entropy garnet-type structure oxide may be prepared by solid state sintering, and the prepared high-entropy garnet-type structure oxide exhibits a uniform distribution of elements.

The following experiments are listed to verify the effect of the disclosure, but the disclosure is not limited to the following content.

### Preparation Example 1: Preparing Li_{6.5}La₃Zr_{0.5}Ta_{0.5}Nb_{0.5}Y_{0.5}O₁₂

First, Li₂CO₃, La₂O₃, ZrO₂, Ta₂O₃. Nb₂O₅, and Y₂O₃ were prepared as raw materials according to the molar ratio in Table 1 below. Then, all the raw materials were ball milled, filtered, dried, ground, and then preliminary calcined (900° C. for 6 hours).

Next, the calcined powder was filtered, dried, ground, and pressed into discs, then high-temperature sintering (1050°° C. for 36 hours) was carried out to obtain a high-entropy garnet-type structure oxide Li_{6.5}La₃Zr_{0.5}Ta_{0.5}Nb_{0.5}Y_{0.5}O₁₂ (hereinafter referred to as L LZTNYO).

### Preparation Example 2: Preparing Li_{6.4}La₃Zr_{0.4}Ta_{0.4}Nb_{0.4}Y_{0.6}W_{0.2}O₁₂

Li₂CO₃, La₂O₃, ZrO₂, Ta₂O₃, Nb₂O₅, WO₃, and Y₂O₃ were prepared as raw materials according to the molar ratio in Table 1 below. Then the same process as Preparation example 1 was adopted structure oxide to obtain a high-entropy garnet-type Li_{6.4}La₃Zr_{0.4}Ta_{0.4}Nb_{0.4}Y_{0.6}W_{0.2}O₁₂ (hereinafter referred to as LLZTNYWO).

### Preparation Example 3: Preparing Li_{6.5}La₃Zr_{1.5}Ta_{0.5}O₁₂

Li₂CO₃, La₂O₃, ZrO₂, and Ta₂O₃ were prepared as raw materials according to the molar ratio in Table 1 below. Then the same process as Preparation example 1 was adopt, but the temperature of the high-temperature sintering was changed to 1150° C. for 24 hours to obtain a high-entropy garnet-type structure oxide Li_{6.5}La₃Zr_{1.5}Ta_{0.5}O₁₂ (hereinafter referred to as LLZTO). Since LLZTO did not contain yttrium (Y), the set sintering temperature was higher.

### Preparation Example 4: Preparing Li_{6.5}La₃Zr_{1.5}Nb_{0.5}O₁₂

Li₂CO₃, La₂O₃, ZrO₂, and Nb₂O5 were prepared as raw materials according to the molar ratio in Table 1 below. Then the same process as Preparation example 4 was adopted to obtain a high-entropy garnet-type structure oxide Li_{6.5}La₃Zr_{1.5}Nb_{0.5}O₁₂ (hereinafter referred to as LLZNO).

### Preparation Example 5: Preparing Li_{6.5}La₃Zr₁Ta_{0.5}Nb_{0.5}O₁₂

Li₂CO₃, La₂O₃, ZrO₂, Nb₂O₅, and Ta₂O₃ were prepared as raw materials according to the molar ratio in Table 1 below. Then the same process as Preparation example 4 was adopted to obtain a high-entropy garnet-type structure oxide Li_{6.5}La₃Zr₁Ta_{0.5}Nb_{0.5}O₁₂ (hereinafter referred to as LLZTNO).

TABLE 1

| Preparation | | | | | | |
|---|---|---|---|---|---|---|
| example | Product | Zr | Ta | Nb | Y | W |
| 1 | LLZTNYO | 0.5 | 0.5 | 0.5 | 0.5 | — |
| 2 | LLZTNYWO | 0.4 | 0.4 | 0.4 | 0.6 | 0.2 |
| 3 | LLZTO | 1.5 | 0.5 | — | — | — |
| 4 | LLZNO | 1.5 | — | 0.5 | — | — |
| 5 | LLZTNO | 1.0 | 0.5 | 0.5 | — | — |

### Structure Analysis

1. X-ray crystal diffraction analysis (XRD) was performed on the product LLZTNYO of Preparation example 1 and the product LLZTNYWO of Preparation example 2, and the results are shown in FIG. 2. According to FIG. 2, it was observed that the products LLZTNYO and LLZTNYWO, synthesized through solid state sintering, exhibited an evident peak corresponding to PDS card number 80-0457. Thus, both LLZTNYO and LLZTNYWO are single-phase high-entropy oxides.

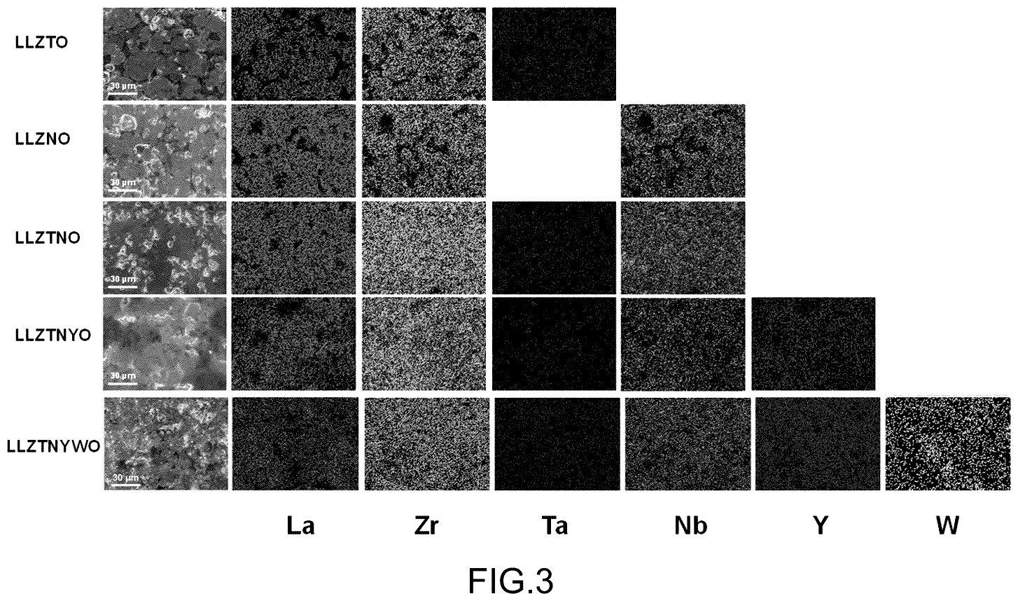

Scanning electron microscopy (SEM)/energy-dispersive X-ray spectroscopy (EDX) analysis was performed on the products of Preparation examples 1-5, and the results are shown in FIG. 3. According to FIG. 3, it is observed that in the high-entropy oxides of Preparation Example 1 and Preparation Example 2, each of the metal elements was uniformly distributed (light color indicates the specified metal). In comparison, the product LLZTO of Preparation Example 3 exhibited the presence of pores and uneven distribution of La and Zr. The product LLZNO of Preparation Example 4 exhibited the presence of pores and uneven distribution of La, Zr, and Nb. The product LLZTNO of Preparation Example 5 exhibited an uneven distribution of La.

In addition, the same result was also obtained through electron microscopy (TEM) EDX analysis.

### Electrochemical Analysis

A BioLogic potentiostat VSP was used to conduct cyclic voltammetry (CV) and constant current cycle test on batteries made of different solid electrolytes. The CV test was performed at a scanning rate of 1 mV s⁻¹, within a potential range between −1V and 6V, on asymmetric lithium/solid electrolyte (i.e., the product of each of Preparation examples)/stainless steel battery to test the electrochemical stability. The constant current cycle test was performed using a symmetrical lithium/solid electrolyte/lithium battery with a current density of 0.1 mA cm⁻² for 1 hour.

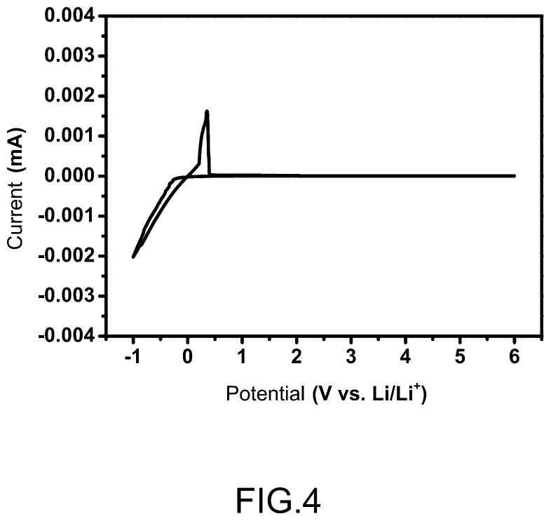

FIG. 4 is a diagram showing a volt-ampere curve of a battery prepared by Preparation example 2. It may be observed from FIG. 4 that there was no evident reaction in a potential range from −1V to 6V, so the solid electrolyte representing Preparation example 2 was very stable to Li/Li⁺ and had a wide electrochemical window.

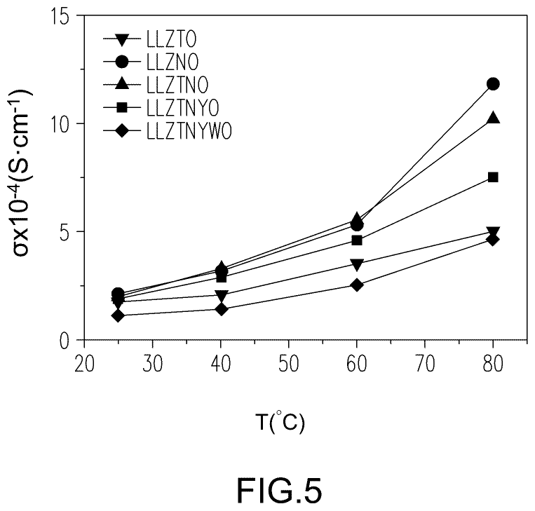

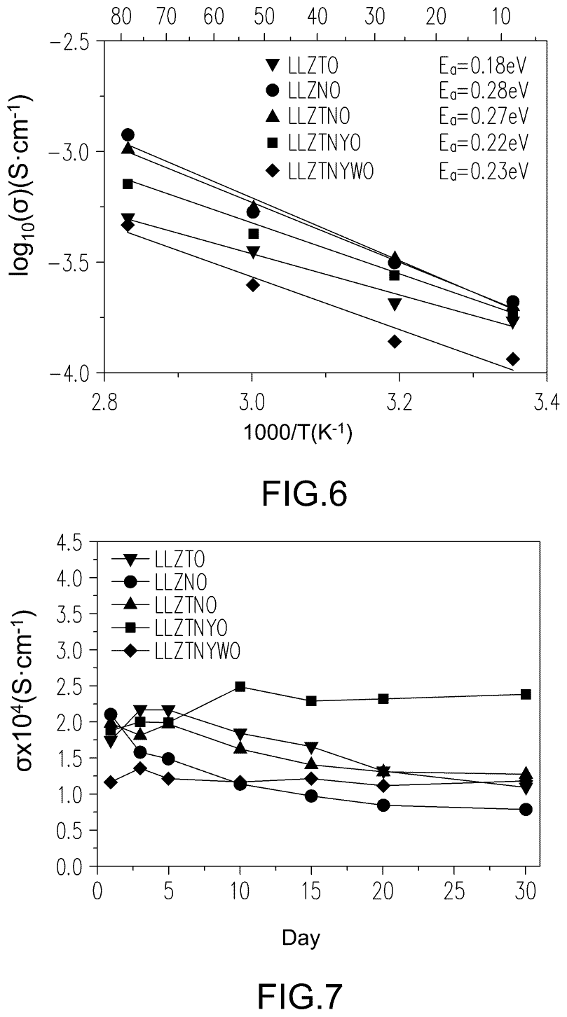

FIG. 5 is a diagram showing ionic conductivity curves of products of Preparation examples 1-5 changing with temperature. FIG. 6 is an Arrhenius plot of products of Preparation examples 1-5. It may be observed from FIG. 5 that all Preparation examples had high ionic conductivity, and from FIG. 6, the activation energy of the product LLZTNYO in Preparation example 1 was relatively low.

Then the ionic conductivity of the product of Preparation examples 1-5 that changed over a long time were measured to obtain FIG. 7. It may be observed from FIG. 7 that the product LLZTNYO of Preparation example 1 showed the best ionic conductivity retention after 30 days, and the product LLZTNYWO of Preparation example 2 also showed excellent ionic conductivity retention after 30 days. Moreover, the high ionic conductivity was also retained after being stored in the atmosphere for 30 days. Although the high-entropy garnet-type structure oxide of Preparation examples 1-2 had some reaction on surface, their dense structure can suppress the influence of carbon dioxide and maintained high ionic conductivity. In comparison, although the ionic conductivity of the products of Preparation examples 3-5 may have good ionic conductivity at the beginning, it attenuated significantly with time. For example, although the ionic conductivity of the product LLZTO of Preparation example 3 was the highest on day 5, the ionic conductivity thereof has dropped to a lower level than that of Preparation example 2 on day 30.

### All Solid-State Lithium-Ion Battery

The electrochemical performance of the all solid-state lithium-ion battery was measured in a CR2032 coin cell, which utilized lithium metal as the negative electrode and LiFePO₄ as the positive electrode. During the assembly of the positive and negative electrodes with the solid electrolyte of Preparation Example 2. 10 μl 4 mol. % LiTFSI doped in butanedinitrile (SN) and 5 vol. % fluoroethylene carbonate (FEC) were used as the interfacial layer material on two sides of the solid electrolyte.

### Liquid Electrolyte Battery

The liquid electrolyte used in the liquid electrolyte battery was 1M LiPF₆ in a mixture of ethylene carbonate and diethyl carbonate (1:1 volume ratio), and Celgard 2500 was used as the separator of the liquid electrolyte battery. The rest of the structure was similar to the all solid-state lithium-ion battery.

### Charge/Discharge Cycle Test

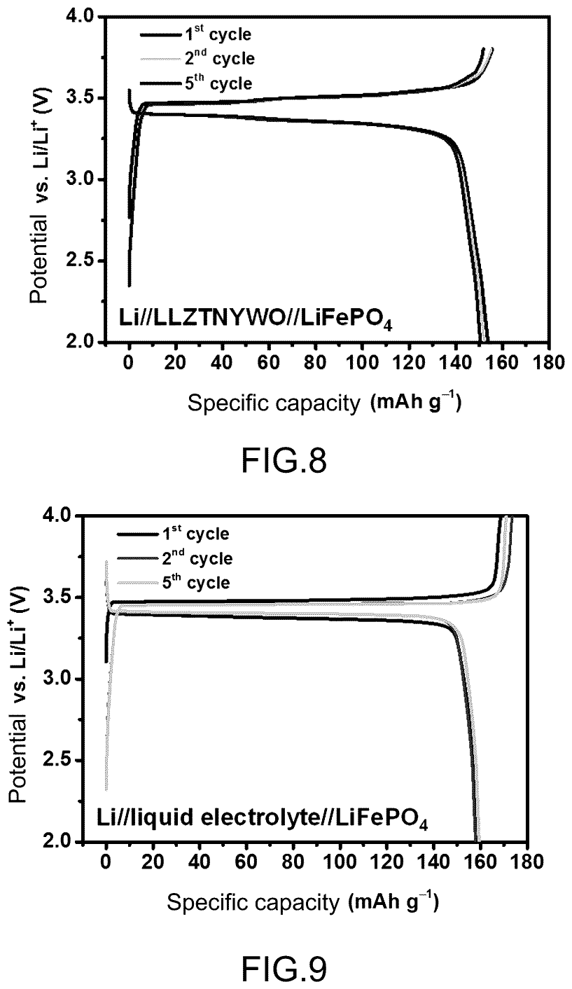

The constant current charge/discharge (GCD) curve was measured by the NEWARE battery testing system (CT-4008-5V 10mA) within a potential range of 0˜3.8 V vs Li/Li+. FIG. 8 and FIG. 9 are diagrams showing the curves of the charge/discharge cycle test for the aforementioned all solid-state lithium-ion battery and the liquid electrolyte battery respectively.

From FIG. 8 and FIG. 9, in the first discharge cycle, the specific capacity of the liquid electrolyte battery was 156 mAh g⁻¹, and the specific capacity of the all solid-state lithium-ion battery was 154 mAh g⁻¹, which was about 97% of the capacity of the liquid electrolyte battery. Moreover, after multiple charge/discharge cycles, the all solid-state lithium-ion battery may still maintain a high capacity of 152 mAh g⁻¹. Thus, the all solid-state lithium-ion battery of the disclosure may achieve high capacity similar to that of liquid electrolyte battery, and may also maintain excellent thermal stability and stability in the atmosphere.

To sum up, the disclosure utilizes the high-entropy effect to form a single-phase oxide of multi-doped garnet, thereby creating a solid electrolyte material for lithium-ion batteries with excellent structural stability and atmospheric stability. Furthermore, the experiments conducted above have demonstrated that the solid electrolyte with high-entropy garnet-type structure in the disclosure maintains good ionic conductivity even after being stored under atmospheric conditions for 30 days. Moreover, when incorporated into an all solid-state lithium-ion battery, it exhibits a comparable capacity to a liquid electrolyte battery. These results indicate that the high-entropy garnet-type structure oxide in the disclosure is a safe and effective solid electrolyte material that improves the characteristics of lithium-ion batteries.

Although the disclosure has been described in detail with reference to the above embodiments, they are not intended to limit the disclosure. Those skilled in the art should understand that it is possible to make changes and modifications without departing from the spirit and scope of the disclosure. Therefore, the protection scope of the disclosure shall be defined by the following claims.

What is claimed is:

1. A solid electrolyte with high-entropy garnet-type structure, comprising a high-entropy garnet-type structure oxide represented by following formula (1):
LiₐLa₃Zr_{b}Ta_{c}M1_{d}M2ₑM3_{f}O₁₂ (1)
In the formula (1), M1, M2, and M3 are respectively W, Sc, Sn, Nb, Y, Si, Sb, Te, Ti, Mo, Mg, or Nd, b+c+d+e+f=2, 5<a<8, 0.01<b<0.6, 0.01<c<0.6, 0.01<d<0.6, 0.01<e<0.6, and 0≤f<0.6.

2. The solid electrolyte with high-entropy garnet-type structure according to claim 1, wherein b, c, d, e, and f in the formula (1) have identical values.

3. The solid electrolyte with high-entropy garnet-type structure according to claim 1, wherein M1, M2, and M3 in the formula (1) are W, Nb, and Y.

4. The solid electrolyte with high-entropy garnet-type structure according to claim 3, wherein the high-entropy garnet-type structure oxide comprises Li_{5.8}La₃Zr_{0.4}Ta_{0.4}Nb_{0.4}Y_{0.4}W_{0.4}O₁₂, or Li_{6.4}La₃Zr_{0.4}Ta_{0.4}Nb_{0.4}Y_{0.6}W_{0.2}O₁₂.

5. The solid electrolyte with high-entropy garnet-type structure according to claim 1, wherein f in the formula (₁) is _{0.}

6. The solid electrolyte with high-entropy garnet-type structure according to claim 5, wherein b, c, d, and e in the formula (₁) have identical values.

7. The solid electrolyte with high-entropy garnet-type structure according to claim 5, wherein the high-entropy garnet-type structure oxide comprises Li_{6.5}La₃Zr_{0.5}Ta_{0.5}Nb_{0.5}Y_{0.5}O₁₂.

8. The solid electrolyte with high-entropy garnet-type structure according to claim 1, wherein the high-entropy garnet-type structure oxide is prepared by solid state sintering.

9. An all solid-state lithium-ion battery, comprising:
a positive plate;
a negative plate, disposed opposite to the positive plate; and
the solid electrolyte with high-entropy garnet-type structure according to claim 1, disposed between the positive plate and the negative plate.
